(19) United States
(12) Patent Application Publication
(10) Pub. No.: US 2009/0325140 A1
(43) Pub. Date: Dec. 31, 2009

(54) METHOD AND SYSTEM TO ADAPT COMPUTER-BASED INSTRUCTION BASED ON HEURISTICS

(76) Inventors: Lou Gray, Bellevue, CA (US); Nigel J. Green, Bellevue, WA (US); Daniel R. Kerns, Mercer Island, WA (US); Roy Leban, Redmond, WA (US); Becca Lewis, Tacoma, WA (US); Benjamin W. Slivka, Clyde Hill, WA (US); Mickelle Weary, Bellevue, WA (US)

Correspondence Address: HAHN AND MOODLEY, LLP, 548 Market Street, San Francisco, CA, 94104, US

(21) Appl. No.: 12/165,648

(22) Filed: Jun. 30, 2008

(51) Int. Cl. G09B 7/00

(52) U.S. Cl. 434/353

(57) ABSTRACT

Embodiments of the present invention disclose a method for adapting a lesson. The method comprises for a given learner, forming an expectation of the learner's performance in answering questions of a lesson; adapting the lesson a first time based on the expectation; evaluating the learner's actual performance in answering questions of the adapted lesson; and selectively adapting the lesson a second time if a difference between the expectation and the actual performance is greater than a threshold.

### FIELD

Embodiments of the present invention relate to computer-based instruction.

### BACKGROUND

Computer-based instruction involves the presentation of instructional/educational content to a user by means of a computer. The educational content may be embodied in a software program that presents the educational content to the user in an interactive manner.

### SUMMARY OF THE INVENTION

According to a first aspect of the invention, there is provided an adaptive method for adapting computer-based instruction in the form of lessons to suit an individual learner. In one embodiment, the adaptive method comprises making observations about the learning behavior of the student, and using heuristics to imply an assessment of the learner's performance in terms of one or more performance or assessment criteria/axes, based on the observations. The assessment is then used to drive or control adaptation of the lesson.

In one embodiment, the assessment and the adaptation occur continuously. Thus, advantageously, the adaptive method allows adaptation of a lesson while a learner is interacting with the lesson.

In some embodiments, the assessment axes may include the following:
Responsiveness
Correctness of answer
   (Final result)
   (How they got there)
Number of interactions
Assistance provided
Strategy used
Change in responsiveness
Quantity of start-overs

In one embodiment, the adaptive method comprises providing a mechanism for teachers to describe how they expect students of varying levels of developmental understanding to perform for a given set of questions. This mechanism, referred to herein as the “expectation matrix” can utilize as many of the above assessment axes as the teacher feels are relevant for a question. In one embodiment, student responses on the varying axes are not taken in isolation, but rather are used in combination to determine an overall score.

Corresponding to each level of development understanding defined in the expectation matrix, in one embodiment, there is a corresponding set of adaptation control parameters to control adaptation of a lesson for a learner determined to fall within that level of development understanding.

Adaptation of a lesson may be in accordance with one or more adaptation criteria or adaptation axes. In one embodiment, the adaptation criteria include the following:
Problem type
Problem difficulty
Problem complexity
Problem presentation
Quantity and level of instruction
Quantity and level of assistance
Pacing
Amount of repetition
Rate of change of problem difficulty
Rate of change of problem complexity

In one embodiment, an adaptation profile maps a desired order and combination of adaptation axes to a particular learner based on the aforesaid overall score for the learner.

According to a second aspect of the invention, there is provided a system to implement the adaptive method.

Other aspects of the invention will be apparent from the detailed description below:

### BRIEF DESCRIPTION OF THE DRAWINGS

FIG. 1 shows a flowchart for the adaptive learning method of the present invention, in accordance with embodiment.

FIGS. 2 and 5 each illustrate an expectation matrix, in accordance with one embodiment of the invention.

FIG. 3 shows a block diagram of a client learning system, and a server learning system, each in accordance with one embodiment of the invention.

FIG. 4 shows a block diagram of a lesson execution environment, in accordance with one embodiment of the invention.

FIG. 6 shows a flowchart for lesson execution, in accordance with one embodiment of the invention.

FIG. 7 shows a table mapping particular micro-objectives to lessons, in accordance with one embodiment.

FIG. 8 illustrates particular lesson sequences associated with different learners.

FIG. 9 shows a server execution environment, in accordance with one embodiment of the invention.

FIG. 10 shows an example of hardware that may be used to implement the client and server learning systems, in accordance with one embodiment.

### DETAILED DESCRIPTION

In the following description, for purposes of explanation, numerous specific details are set forth in order to provide a thorough understanding of the invention. It will be apparent, however, to one skilled in the art, that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

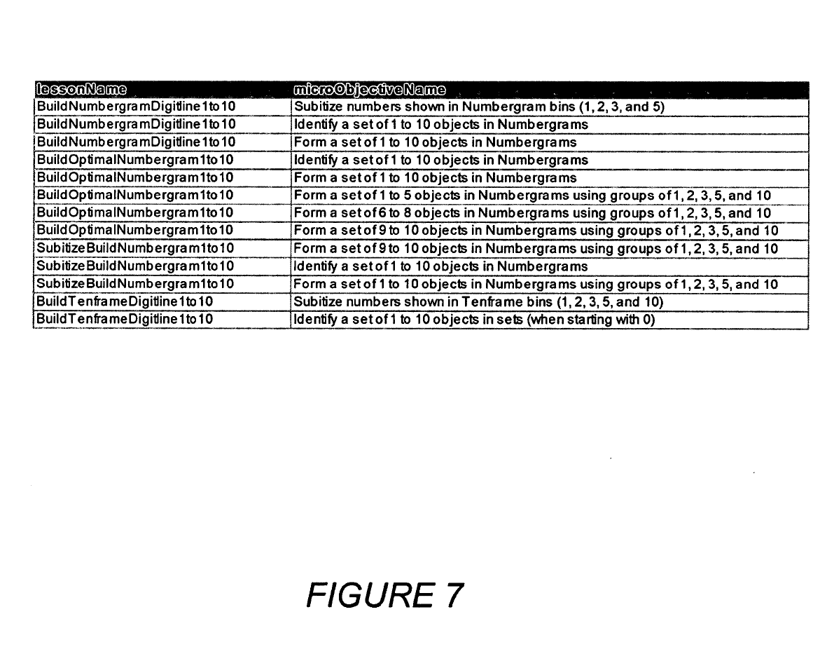

Embodiments of the present invention disclose an adaptive learning method whereby lessons are adapted to ensure suitability to a particular learner. Within the context of the present invention, lessons teach a variety of subjects such as math, science, history, languages, etc. Lessons may comprise problems, each associated with a particular skill or micro-objective (FIG. 7 provides a table that maps micro-objectives to lessons). For example, a problem could relate to the micro-objective of comparing two numbers to determine which is more or which is less. Within a lesson, a problem is presented in the context of questions that are presented either sequentially or in parallel (can be answered in any order, but must all be answered) and test whether a student has a grasp of the particular micro-objective(s) associated with the problem. A learning system that implements the adaptive learning method is also within the scope of the present invention.

A glossary of terms useful for understanding the present invention is provided in Appendix A.

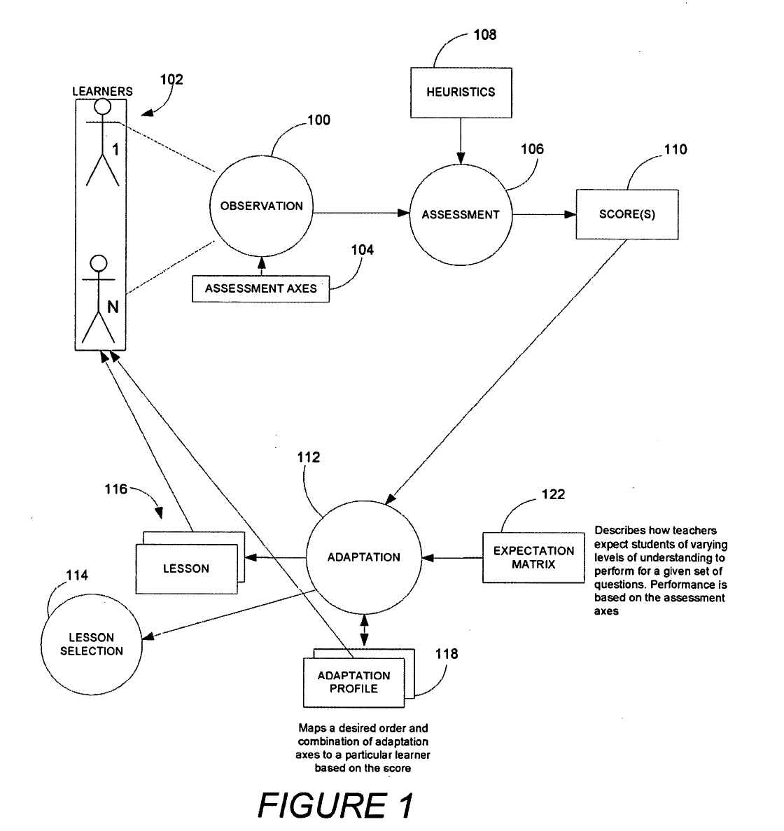

FIG. 1 of the drawings provides an overview of the adaptive method of the present invention, in accordance with one embodiment. Referring to FIG. 1, an observation process 100 is performed in order to observe the learning behavior of a plurality of learners 102. The observation process 100 collects data about the learning behavior of a student and passes this data to an assessment process 106 wherein one or more algorithms are executed to form an assessment of the student's learning developmental level. The algorithms may be configured to assess the student's learning behavior along particular axes of assessment. Instances of axes of assessment in include things like interactions (i.e. the number of interactions required to solve a problem), mistakes while answering (i.e. the number and types of mistakes made while answering questions posed as part of the adapted learning method), etc.

More detail on possible axes of assessment is provided in Appendix B.

In one embodiment, the assessment of the student's learning behavior is embodied in one or more scores 110 that are the output of the assessment process 106. The scores are indicative of the student's learning developmental level and are determined based on heuristics 108.

Since the assessment process 106 uses the data generated by the observation process 100, the type of data that is collected/generated by the observation process 100 is based, at least in part, on the particular assessment axes 104 the assessment process 106 is configured to assess.

Advantageously, a system implementing the adaptive method of FIG. 1 may be configured to assess learning behavior along a plurality of assessment axes selected to provide a fine-grained evaluation of learning behavior.

Continuing with FIG. 1, the scores 110 are fed into an adaptation process 112 which adapts lessons on a student-by-student basis based on the scores 110 for the student. In one embodiment, the adaptation process 112 includes a lesson selection process 114. The lesson selection process 114 selects a subset 116 of lessons for a particular learner. The subset 116 is selected from a universe of lessons available within the learning system based upon the learner's observed skills and knowledge, as represented by said learner's scores 110 in specific lesson areas. Each lesson may have one or more prerequisites that must be satisfied before the lesson may be taken. For example, a prerequisite for a lesson may require that for the micro-objective(s) being assessed by the lesson that a student has a score that falls between an upper and a lower limit before that lesson may be taken. In one embodiment, the subset 116 of lessons comprises those lesson whose prerequisites in terms of micro-objective scores are satisfied for the particular learner. Within the subset 116, a student has freedom to select or take any lesson. Thus, a student is not forced to take the lessons in the subset 116 in a particular order.

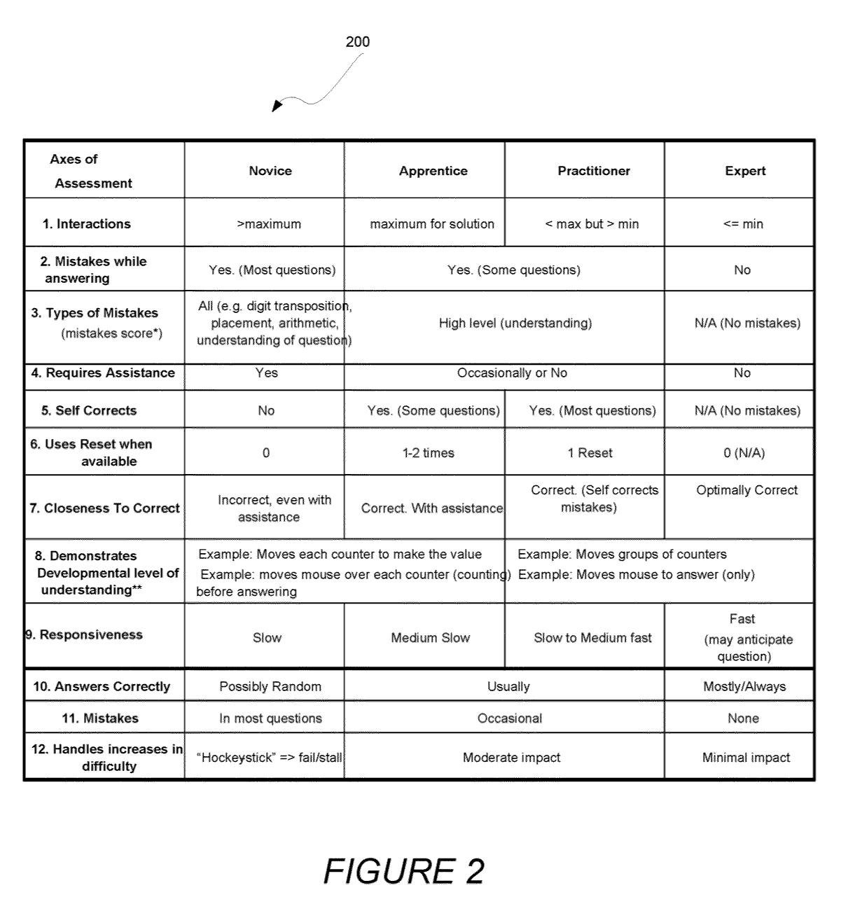

In one embodiment, the particular lessons within the subset 116 may themselves be adapted under the adaptation process 112. More particularly, the adaptation process 112 uses an expectation matrix 122 and the scores 110 to generate an adaptation profile 118. In one embodiment, the expectation matrix 122 describes how teachers expect students of varying levels of understanding to perform for a given set of questions within a lesson. An example of the expectation matrix 122 is provided in FIG. 2, where it is indicated by reference numeral 200. The adaptation profile 118 maps a desired order and combination of adaptation axes to a particular learner based on the score(s) 110 for the learner.

The expectation matrix 200 shown in FIG. 2 of the drawings will now be described. Referring to the expectation matrix 200, it will be seen that there are twelve axes of assessment. Further, for each lesson and for each axis of the assessment there is an expectation of a student's learning performance in terms of that particular axis of assessment. In one embodiment, the expectation of a student's performance may be based on categories of students, where each category corresponds to a particular developmental level of understanding. For example, the expectation of performance may be presented in terms of categories labeled novice, apprentice, practitioner, and expert. Each category corresponds to a particular development level of understanding, with the level of understanding increasing from novice to expert. It should be kept in mind that embodiments of the invention may be practiced using different categories for developmental level understanding, or even no categories at all.

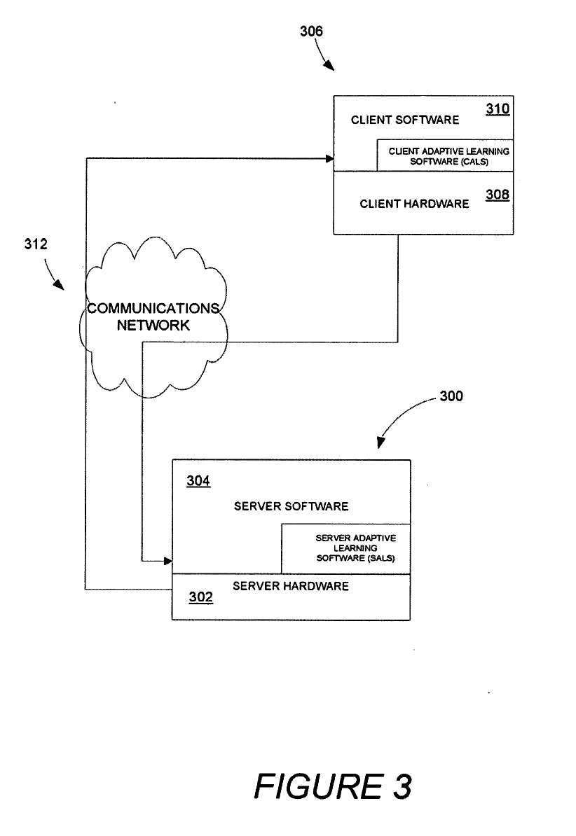

Aspects of the above-described adaptive learning method may be performed by a client learning system communicatively coupled to a server learning system, as is illustrated in FIG. 3 of the drawings. Referring to FIG. 3, a server learning system 300 may be connected to a client learning system 306 via a communications network 312 which facilitates information exchange between the two systems.

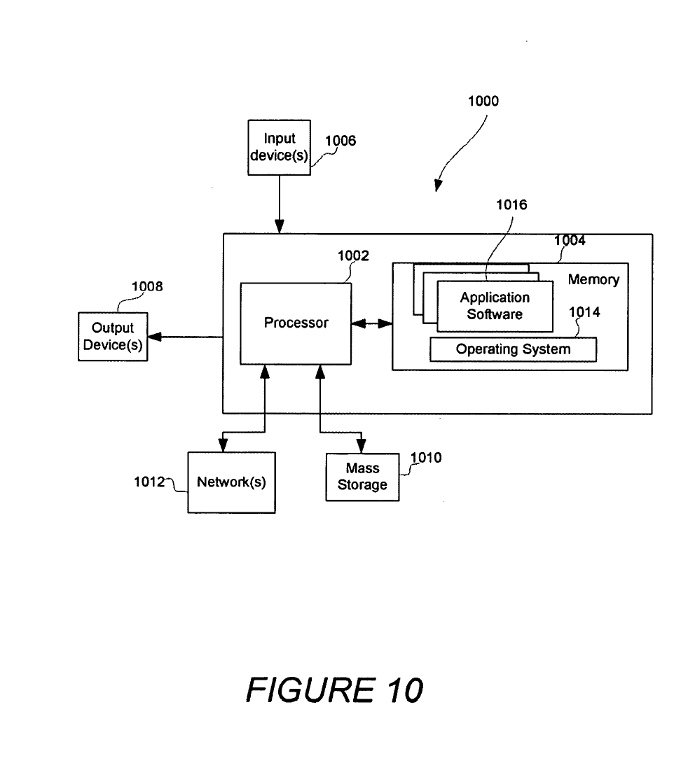

In one embodiment, the server learning system 300 may include one or more servers each including server hardware 302 and server software 304. The particular components of the server hardware 302 and the server software 304 will vary in accordance with different implementations. One example of the hardware 302 and the software 304 used to realize the server system 300 is provided in FIG. 10 of the drawings. For implementing the adaptive method of the present invention the server software 304 comprises Server Adaptive Learning Software (SALS). The functions of the SALS will be described later.

The client learning system 310 represents any device such as a desktop or laptop computer, a mobile phone, a Personal Digital Assistant (PDA), an embedded system, a server appliance etc. Generically, the client learning system 310 includes client hardware 308 and client software 310 and may be implemented as the system 1000 described below with reference to FIG. 10 of the drawings. Inventively, the client learning system 300 includes Client Adaptive Learning Software (CALS) to perform the adaptive method of the present invention and whose functioning will be described in greater detail later. In one embodiment, the CALS may be run on the client learning system 300 as a web-download from the server learning system 300.

In one embodiment, the communications network may comprise a Wide Area Network (WAN), to support communications between the server learning system 300 and the client learning, system 306 in accordance with different communications protocols, By way of example, the communications network may support the Transmission Control Protocol over the Internet Protocol (TCP/IP). Thus, the communications network 312 may comprise the Internet.

In one embodiment, a learner (also referred to herein as “a student” or “user”) downloads software from the server learning system 300 over the communications network 312. The term “software” is used herein to indicate one or more software programs comprising instructions that are machine-executable or virtual machine-executable, as well as data associated with the execution of the programs. In one embodiment, the software may be downloaded from the server learning system 300. In other embodiments, the software may include executable instructions pre-installed on the client adaptive learning system.

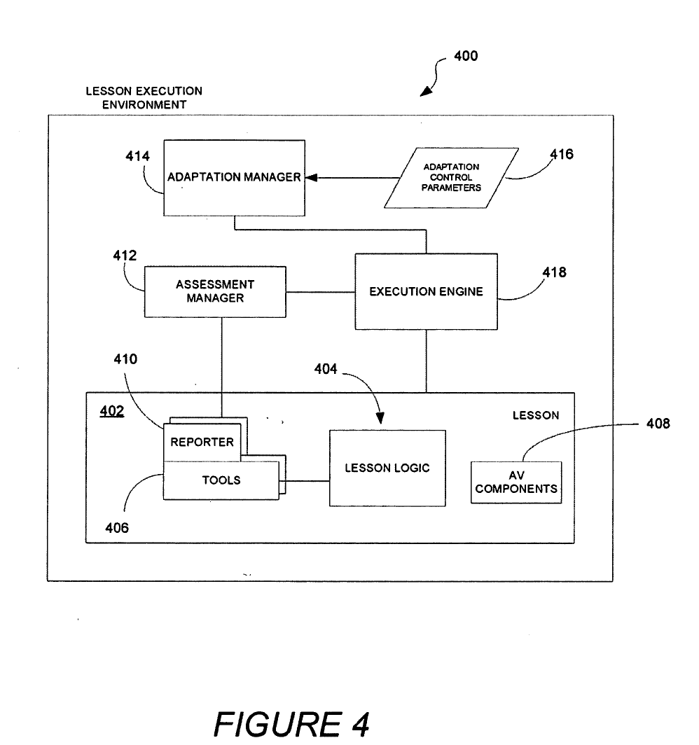

Each lesson when executing on the client learning system 306 has a lesson runtime or execution environment. FIG. 4 of the drawings shows a graphical representation of a lesson execution environment 400, in accordance with one embodiment of the invention. As will be seen, the lesson execution environment 400 includes a lesson 402. The lesson 402 includes lesson logic 404 that comprises instructions to control what happens during a lesson. The lesson 402 may include one or more tools 406 which provide the functionality needed in a lesson. The tools 406 may include visible tools, such as a tool which displays a number, an abacus, a chart, a lever, or a chemical symbol. The tools 406 may also include invisible tools, such as a tool which performs a mathematical calculation or generates problems of a particular type. The tools 406 are used to pose questions to a learner. The lesson 402 also includes audio/visual (AV) components 408 that comprise audio and visual instructional material associated with the lesson. Associated with each tool 406 is a reporter 410 which collects metrics/data relating to a student's use of the tool 406 and reports the metrics to an assessment manager 412. The observation process 100 described with reference to FIG. 1 is performed by the reporters 410. In accordance with different embodiments, the actual metrics reported by the various reporters 410 may be processed in a variety of ways which will be dependent upon the particular axes of assessment that the assessment process 100 is configured to evaluate. In one embodiment, the axes of assessment include responsiveness, correctness of the answer, number of interactions, assistance provided, strategy used, change in responsiveness, quantity of start overs, etc. These axes of assessment are described in Appendix B, with reference to FIG. 2.

In one embodiment, the assessment manager 412 performs the assessment process 106 by computing a Question Score upon the completion of a question (i.e. there is no opportunity for the student to make any further changes) based on the metrics received from the reporters 410. The Question Scores may be in the range of 0 to 100.

### Question Scores

Each question posed in a lesson assesses a specific micro-objective. (Where two or more questions are asked in parallel, two or more micro-objective will be assessed). Thus, a Question Score is the score(s) for the micro-objective(s) associated with a lesson. In accordance with the embodiments of the present invention, in determining a Question Score, the assessment manager 412 generates a value based on at least the responses for each assessment axis, weighted by a teacher-supplied value, a difficulty level of the question, and an assistance score. Notionally, the Question Score for a particular question may be regarded as the maximum possible score for that question adjusted by the type and quantity of the mistakes made and assistance provided.

In one embodiment, the maximum possible score for a question is calculated as:

(CAS*D)

### Where:

CAS=Correct Answer Score (Normally 100)
D=Difficulty (e.g. in the range 0.5 to 2.5)

The values CAS and D are assigned by a teacher and are independent variables.

By way of example, and in one embodiment for a correct answer, the following is used to calculate the Question Score:

QS=(CAS*D)−W_{M}*MS−W_{A}*AS+W_{R}*RS+W_{S}*SS

### Where:

QS=Question Score
CAS=Correct Answer Score (Normally 100)
D=Difficulty
W_{M}=Mistakes Score Weighting
MS=Mistakes Score
W_{A}=Assistance Weighting
AS=Assistance Score
W_{R}=Responsiveness Score Weighting
RS=Responsiveness Score
W_{S}=Strategy Score Weighting
SS=Strategy Score

Appendix C describes how MS, AS, RS, SS, and their respective weightings are computed, in one embodiment. The learner's scores for each assessment category (i.e. the values MS, AS, RS, and SS) in the above formula are modified by weighting values that allow for fine tuning of how a series of lessons evaluate similar responses where expectations if student performance differ. For example, there may be two lessons, viz. Lesson 1 and Lesson 2, with the questions of Lesson 2 being more difficult than the questions of Lesson 1. Given the difference in the difficulty of the questions in the two lessons, a teacher would expect a student to make more mistakes in Lesson 2. Moreover, the Lesson 2 may be configured to provide more assistance to a student. Thus, a lower weighting for mistakes and assistance may be set for Lesson 2 than for Lesson 1. The weighting values are a combination of at least two separate values: one supplied by the author of the lesson, and the other generated by the system which is used to optimize the weighting effectiveness over time.

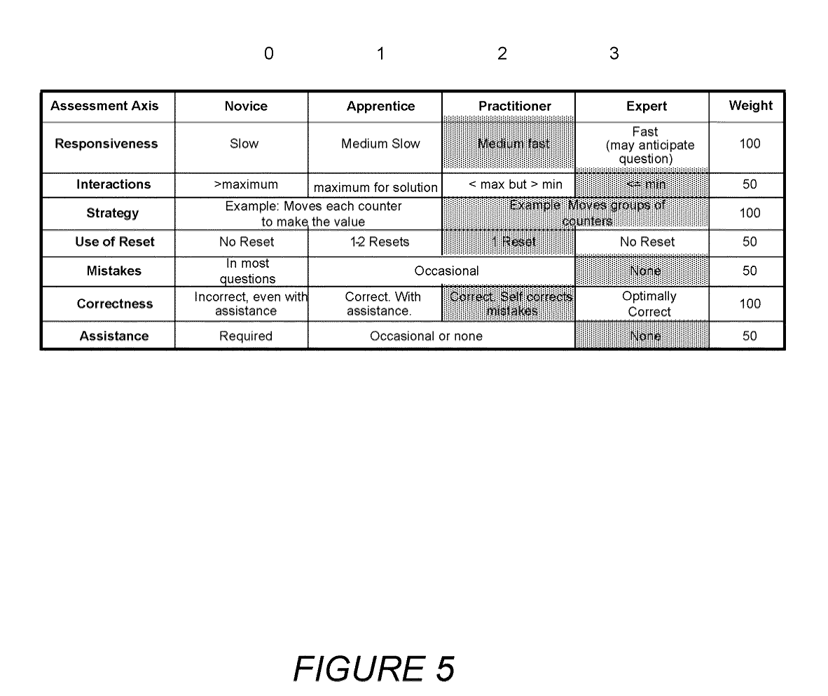

To illustrate how Question Scores are calculated, consider the expectation matrix 500 shown in FIG. 5 of the drawings. In this matrix, the stippled areas indicate a particular learner's categorization selected from the developmental categories novice to expert for each of the axes of assessment shown. As can be seen, the learner is in the category “practitioner” for responsiveness and in the category “expert” for interactions. The individual scores for each of the axes of assessment are determined by the assessment manager 412, in accordance with the techniques described above. The maximum and the minimum values for the interactions are teacher-supplied. In one embodiment, the scores for responsiveness in each category may be actual timings provided by a teacher. In other embodiments, said scores may be expressed in terms of a measure of statistical dispersion such as the standard deviation for a population of students.

For the illustrative purposes, in the matrix 500, a novice is given zero points, an apprentice one point, a practitioner two points, and an expert three points. These values are supplied by a teacher. The teacher also supplies the weights for each axis of assessment. Using the above formula to calculate the Question Score, the matrix 500 yields a Question Score of 76 for a value D of 1.0.

Using an expectation matrix 122 and a formula similar to the one described to determine a Question Score; a teacher can determine an expected Question Score for a learner in each of the listed developmental categories described above. In accordance with one embodiment, a difference between the actual Question Score and the expected Question Score based on the learner's developmental level can be used to perform intra-lesson adaptations during execution of a lesson on the client learning system, as will be described.

### Current Performance and Micro-Objective Scores

After each question is answered, in one embodiment, both Current Performance and Micro-objective scores are calculated. These provide, respectively, a general indication of how the student is performing on the lesson overall at that moment, and how well the student is responding to questions of either a specific type or covering specific subject matter. Both the Current Performance and the Micro-Objective Scores for a particular student represents a mastery quotient for subject matter that a lesson is designed to teach.

Both these scores are generated by calculating a weighted average of the last N Question Scores.

The Current Performance Score looks back over all recent answers of all types, while the Micro-objective Score is based upon answers to questions of a single type.

Only the last N Question Scores are used when generating these derived scores for the following reasons:
It is assumed that more recent responses are more indicative of the current state of student learning.
The expectation is for the student to improve during the lesson (assuming the difficulty level remains constant). Mistakes later in the lesson therefore take on more significance.
By using a decaying weighting on answers, the effect of early mistakes is diminished, or in some cases excluded entirely, while the effect of later mistakes is magnified.

There are two specific ways of processing Question Scores: One treats the scores obtained when answering each question as absolute and does not take into account what the possible maximum was. The other essentially adjusts the accumulated score in relation to what was possible for each question.

Which approach is used is determined by the type of lesson. The majority of lessons contain phases where there are multiple problems and either one or a few questions per problem. Some lessons, however, contain a single problem with multiple questions, often of differing difficulty levels. The former case usually requires questions of lower difficulty to be assessed at a lower level. The latter, however, may require that regardless of the difficulty of each individual question, the overall score should be the nominal maximum (100) if no mistakes were made. Even if the individual scores were 80, 80, 80, 80 for a set of questions where the maximum score possible—adjusted, for example, for difficulty—for each was 80.

The formula to calculate either the Current Performance or Micro-objective Scores when all Question Scores are treated independently (the former case) is:

$$S = \frac{{\sum }_{i = 0}^{N} ( {W}_{i} * {Q}_{i} )}{{\sum }_{i = 0}^{N} ( {W}_{i} )}$$

The formula to calculate either the Current Performance or Micro-objective Scores when all questions within a problem must be taken as a whole (the latter case) is shown below. Note that the value ‘N ’ in this case should be equal to the number of questions asked in the problem (and therefore may be variable on a per-problem basis).

$$S = \frac{{\sum }_{i = 0}^{N} ( {W}_{i} * {Q}_{i} )}{{\sum }_{i = 0}^{N} ( {W}_{i} * {Max}_{i} )} * 100$$

### Where:

S=Score
N=Number of Questions to look back over (possibly the number of Questions in the problem)
W_{I}=Weighting at position i in the weighting table
Q=Question Score
Max=MaxPossible Score for the question, based upon the difficulty of that question.

The following are examples of possible weighting tables. The first weights the latest question score (as represented by the right-most position in the table) as 25% more significant than the three preceding it. The second treats the three most recent scores equally and then gradually reduces the impact of scores previous to those:
[0.5, 0.75, 1.0, 1.0, 1.0, 1.25]
[0.25, 0.5, 0.75, 1.0, 1.0, 1.0]

It should be noted that for a given value of N, the two formulas produce differing result only when the difficulty levels of the questions asked varies.

It will be appreciated that each Question Score represents a heuristic used to assess a student's level of developmental understanding.

### Intra-Lesson Adaptation.

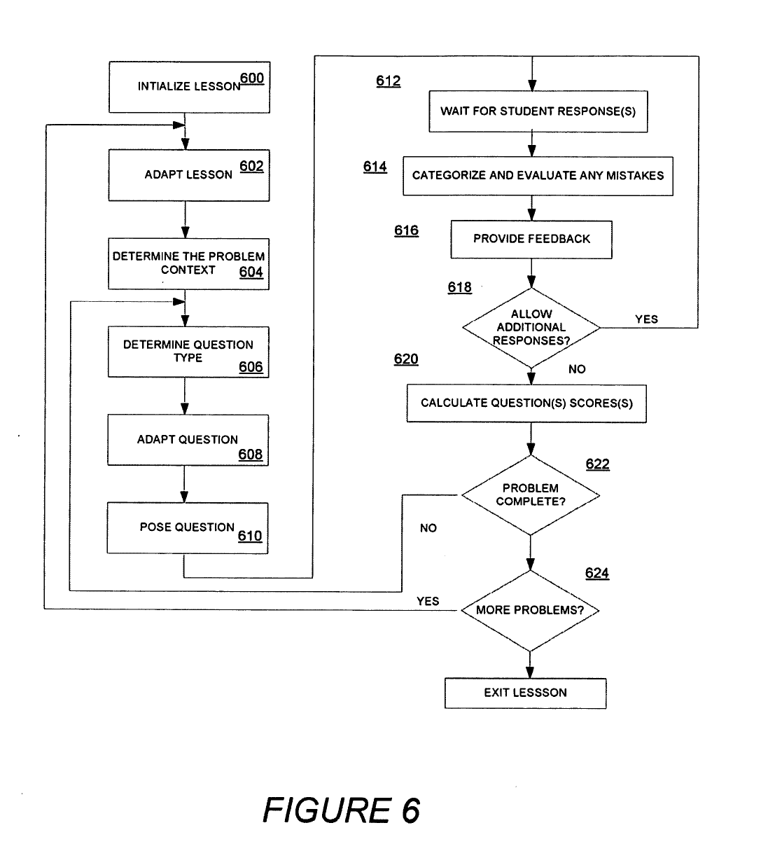

A flowchart of intra-lesson adaptation, in accordance with one embodiment is shown in FIG. 6 of the drawings for a lesson received by the client learning system from the server learning system over the communications network 312. The steps in the flowchart of FIG. 6 are performed by the adaptation manager 414 together with an execution engine 418 which controls overall lesson execution on the client adaptive learning system.

The steps in the flowchart of FIG. 6 include:

### Block 600: Initialize Lesson

### Block 602: Adapt Lesson

The adaptation manager 414 adapts the lesson (this is termed “lesson level adaptation”) using initial adaptation control parameters 416 (see FIG. 4) that are provided by the SALS at the time of lesson delivery. In one embodiment, the initial adaptation parameters 416 are provided by a lesson author (teacher) at the time of authoring the lesson. For example, the teacher may look at a problem and compute expected Question Scores for the problem using the expectation matrix and the formula for the Question Score described above. The teacher may then specify adaptation parameters based on certain thresholds for the expected Question Scores. For example, consider a more/less type problem where a student is given questions with two numbers in a range and then asked to specify which number in more and which is less. In this case, the teacher may specify the adaptation parameters using the following code:

```
ADAPT
  PERFORMANCE_SCORE >= 80
      play ”Let's try numbers up 20”
      // Set the range of possible number that can be generated
      setMinMax (1,20)
      // Increase the perceived difficulty level
      Difficulty (1.2)
      // Set the smallest and largest difference between the two
      // numbers to be compared
      setDifferenceMinMax (1,2)
      // Reduce the amount of instruction and assistance provided
      // automatically
      AssistanceLevel = LOW
      InstructionLevel = LOW
  EXIT
      // If the student leaves this section, reset the difficulty score
      // and the range of possible numbers
      Difficulty (1.0)
      setMinMax (1,10)
  PERFORMANCE_SCORE >= 50
      AssistanceLevel = MODERATE
      setDifferenceMinMax (3, 5)
  PERFORMANCE_SCORE <= 30
      InstructionLevel = LOTS
      AssistanceLevel = LOTS
      setDifferenceMinMax (5,7),
END_ADAPT
```

As can be seen the adaptation parameters 416 are set based on expected Question Scores and include changes in the level of instruction, the level of assistance, the minimum and maximum distances between the numbers being compared, etc. Another example of a lesson level adaptation includes weighting/rebalancing “choosers”. Choosers are used by the lesson infrastructure to choose quasi-randomly between a limited set of choices. Rebalancing a chooser changes the probability that each choice might be chosen. Possible choices might include things such as which tools might be available, or which operation (e.g. subtraction, addition, equality, etc.) is to be tested in the next question. Another type of lesson level adaptation may be transitioning the lesson to a different state. Yet another type of lesson level adaptation may be enabling/disabling lower-level (more specific) adaptations.

### Block 604: Determine The Problem Context

Problem context includes the many individual user interface (UI), tool and generator (a tool used to generate a problem) configurations that make a set of problems, as presented to the student.

### Block 606: Determine The Question Type

This could, for example, involve using a chooser to select the type of operation to be performed.

### Block 608: Adapt Question

Adaptation is performed if a difference between an expected score and a calculated score is above a certain threshold. Possible adaptations or axes of adaptation include changes in the following:
Problem Type
Problem Difficulty
Problem Complexity
Problem Presentation
Quantity and level of Instruction
Quantity and level of Assistance
Pacing
Amount of Repetition
Rate of Change of problem difficulty
Rate of Change of problem complexity

### Block 610: Pose Question

### Block 612: Wait for Student Response

### Block 614: Categorize and Evaluate any Mistakes

This is done by the assessment manager as described above.

### Block 616: Provide Feedback

This may involve telling the student that the answer is correct/incorrect and perhaps providing some hints or remediation material to help the student.

### Block 618: Allow Additional Responses

Some lessons give partial credit when students correct their work after feedback.

### Block 620: Calculate Scores

This is performed by the assessment manager in accordance with the techniques described above.

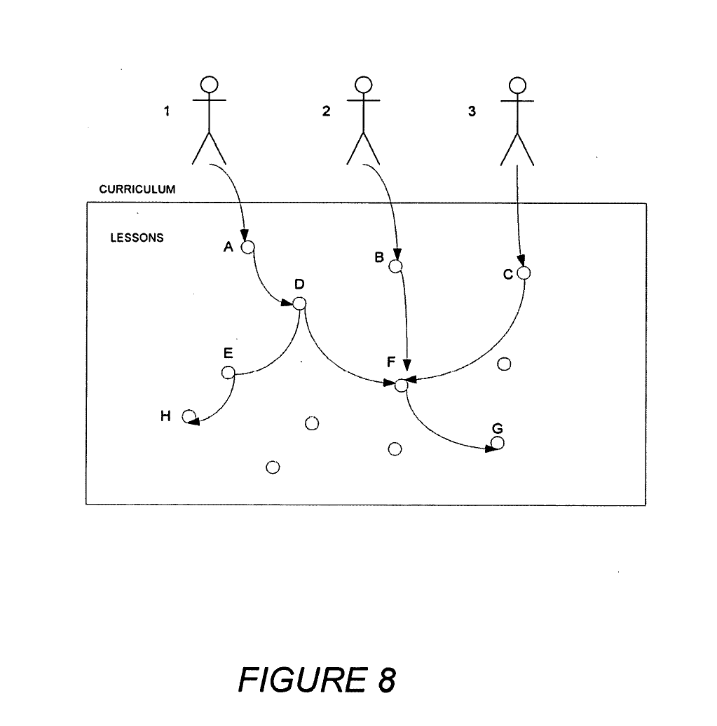

Referring now to FIG. 8 of the drawings, there is shown a graphical representation of a curriculum comprising a plurality of lessons labeled A to G provisioned within the server adaptive learning system. Suppose Student 1 completes Lesson D and based on the scores for the micro-objectives assessed by Lesson D, the lesson selection process 114 indicates that lesson F is desirable. Suppose Student 2 achieves passing scores for the micro-objectives assessed by Lesson B and the lesson selection process indicates that Lesson F is available. Suppose further that Student 3 achieves passing scores for the micro-objectives assessed by Lesson C and then takes lesson F. If Student 1 performs as expected for Lesson F, but Student's 2 and 3 perform poorly, this may indicate that Lesson D is particularly effective in teaching the concepts that are requirements for Lesson F. Thus, by monitoring the performance of students in subsequent lessons that rely upon the micro-objective(s) taught and assessed by a higher node in a lesson sequence it may be found such that students passing through that node perform significantly better in a statistical sense than if they did not take the lesson defined by the higher node. When this happens, in one embodiment the higher node is said to be more effective and the scores from the higher node (lesson) are given greater weight. In the scenario given above, the scores for the nodes/lessons B and C may be scaled down relative to the scores for the node D. The scaling applied to each node (lesson) is referred to as the Effectiveness Factor, and is now described.

### Effectiveness Factor

The effectiveness factor is a measure of how effective a lesson is at teaching certain skills and/or concepts (micro-objectives). As such, the effectiveness factor can be influenced by a variety of factors which may include: the teaching approach used, the learning styles of the students, how well the lesson author executed in creating the lesson, etc. When there are multiple lessons, each attempting to teach and assess the same micro-objectives, the effectiveness of each, for a given group of learners, can be calculated by observing the scores obtained in subsequent common lessons that either require or build upon the skills taught in the preceding lessons. This effectiveness is expressed as the Effectiveness Factors for a lesson which are used to adjust the Micro-Objective Scores obtained from the previous lessons to ensure that they accurately represent the skills of the student and are therefore more accurate predictors of performance in subsequent lessons.

In one embodiment the Effectiveness Factors for a group of lessons are calculated by the system using the scores for all students who have completed those lessons and have also completed one or more common subsequent lessons. One possible algorithmic approach for doing this is as follows:
1. Group all students by which of the previous lessons they completed.
2. Process the scores of each group to generate indicative “performance value(s)” (PV) for the group as a whole. These values may be based upon not just the scores in the subsequent lesson, but also their difference from those obtained in the previous lesson.
3. IF the difference between PV's for any two groups exceeds a defined threshold, THEN
   a. FOR EACH of the previous lessons:
      i. Calculate the percentage difference between the PV of the lesson and the highest performing lesson
      ii. Generate an Effectiveness Factor for the lesson based upon the percentage difference (for example by subtracting the difference from 100)
      iii. Use the Effectiveness Factor for each lesson to scale the scores obtained with that lesson.
4. Where there are no lessons teaching and assessing common micro-objective, or where the difference in PV between the lessons does not exceed the threshold the Effectiveness Factor is set to its maximum (nominally 100).

The above steps may be repeated at defined intervals in order to re-calculate the Effectiveness Factors for a lesson. In some cases, the Effectiveness Factors for a lesson may be adjusted or updated based on the re-calculated values.

In another embodiment the students may additionally be first divided into groups that emphasize their similarities and a process—perhaps very similar to that described above—is then run for each group. This would result in multiple Effectiveness Factors per lesson, one per group. In another embodiment students could be placed successively into multiple groups and the process run multiple times for each combination of groups.

In another embodiment the algorithm may include not just the immediate predecessor lessons, but also any sets of equivalent lessons that may have preceded them.

### Key Lessons

In one embodiment, these are lessons that have an Effectiveness Factor for a particular micro-objective that is above a threshold, say 85%. Within a curriculum, a key lesson may be highly desirable in contrast with a lesson with an Effectiveness Factor of less than say 50%. In some embodiments, lessons with Effectiveness Factors of less than a threshold, say 30%, may be removed from the system.

In another embodiment it may be determined that students with certain learning styles (e.g. Visual vs. Auditory) may all perform better when presented with one style of lesson rather than another. In those cases each of the group of similar lessons may have more than one Effectiveness Factor—one for each group of students that share a common learning style where there is an observed different level of effectiveness.

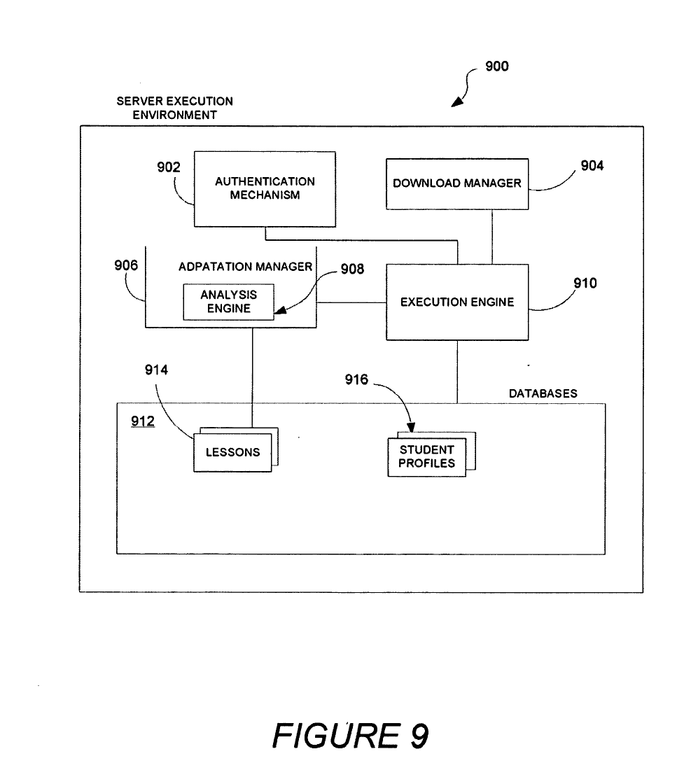

Referring now to FIG. 9 of the drawings, there is shown a block diagram of a server execution environment 900 implemented at runtime on the server adaptive learning system of the present invention. The components of the execution environment 900 will now be described.

### 902 Authentication Mechanism

This component implements functionality to authenticate a learner to the system, e.g. by user name and password.

### 904 Download Manager

This component is responsible for sending lessons to a student for execution on the client adaptive learning system.

### 906 Adaptation Manager

In one embodiment, the adaptation manager 906 scales the Question Scores received from a client adaptive learning system to yield a lesson-independent Micro-Objective Score. A formula for computing the lesson-independent Micro-Objective Score is provided in Appendix D. The adaptation manager 906 includes an analysis engine 908 that is responsible for analyzing the Question Scores for a population of students. The analysis engine also calculates the Effectiveness Factors described above.

### 910 Execution Engine

This component controls execution within each of the components of the environment 900.

### 912 Databases

The environment 900 includes one or more databases 912. These include a lessons database 914, and a database 916 of student profiles which comprise the adaptation control parameters for each student.

FIG. 10 of the drawings shows an example of hardware 1000 that may be used to implement the client learning system 306 or the server learning system 300, in accordance with one embodiment of the invention. The hardware 1000 typically includes at least one processor 1002 coupled to a memory 1004. The processor 1002 may represent one or more processors (e.g., microprocessors), and the memory 1004 may represent random access memory (RAM) devices comprising a main storage of the hardware 1000, as well as any supplemental levels of memory e.g., cache memories, non-volatile or back-up memories (e.g. programmable or flash memories), read-only memories, etc. In addition, the memory 1004 may be considered to include memory storage physically located elsewhere in the hardware 1000, e.g. any cache memory in the processor 1002, as well as any storage capacity used as a virtual memory, e.g., as stored on a mass storage device 1010.

The hardware 1000 also typically receives a number of inputs and outputs for communicating information externally. For interface with a user or operator, the hardware 1000 may include one or more user input devices 1006 (e.g., a keyboard, a mouse, etc.) and a display 1008 (e.g., a Liquid Crystal Display (LCD) panel). For additional storage, the hardware 1000 may also include one or more mass storage devices 1010, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 1000 may include an interface with one or more networks 1012 (e.g., a local area network (LAN), a wide area network (WAN), a wireless network, and/or the Internet among others) to permit the communication of information with other computers coupled to the networks. It should be appreciated that the hardware 1000 typically includes suitable analog and/or digital interfaces between the processor 1002 and each of the components 1004, 1006, 1008 and 1012 as is well known in the art.

The hardware 1000 operates under the control of an operating system 1014, and executes various computer software applications, components, programs, objects, modules, etc. indicated collectively by reference numeral 1016 to perform the above-described techniques. In the case of the server system 300 various applications, components, programs, objects, etc. may also execute on one or more processors in another computer coupled to the hardware 1000 via a network 1012, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

### APPENDIX A: GLOSSARY OF TERMS

### Overview

A lesson may have one or more Phases
Each Phase may contain one or more Problems
Each Problem may contain one or more Questions
Each Question assesses a single related Micro-objective.

### Lesson Phases:

A lesson may be divided into one or more logical segments. Each segment is referred to as a “phase” of the lesson.
Each phase is made up of one or more Problems.

### Problems:

A Problem is based upon a single generated set of values that are part of the Problem Context.
A Problem can have one or more parts. Each part is a Question.
If a problem is comprised of more than one question, it is Partially Completed if only some of the questions have been answered.
If a problem is comprised of more than one question, it is Partially Correct if only some of the questions have been answered correctly.
A problem may be:
   Complete And Correct
   Half Correct (50%)
   Mostly Correct (for example >50% correct)
   Mostly Incorrect (for example <50% correct)
   Complete
   Half Complete (50%)
   Mostly Complete (for example >50% correct)
   Mostly Incomplete (for example <50% correct)
Within a problem, Questions can be asked:
   Sequentially—E.g. “Which is More?” then “Which is Less?”
   in Parallel—E.g. “Build the Number shape, select its value on the number line then click the Check My Work button”
   A combination of the above
Some Problems require all questions be answered correctly for the problem to be classed as Correct
Some Problems can provide a reduced score if only some of the questions are answered, or if only some of the answered questions are answered correctly.

### Problem Context:

Is a collection of values that meet a set of rules or constraints that provide the context in which one or more questions can be both posed and answered.
Refers to both the collection of values and the visual representation/tools used to pose and answer the problem.
Does not change significantly within the scope of a problem.
The rules or constraints that define the Problem Context can be changed during the course of the problem to either replace or augment parts of the underlying dataset, provided that this does not reset or replace the entire dataset.
A Problem context (and the underlying dataset) need not be fully populated at the start of the problem, and can have values removed, and/or generated and added to the set as necessary to support (for example) changing question difficulty or different questions within the current problem space.

### Questions:

A Question is based upon the current Problem Context
Each Question assesses a single related Micro-objective.
Within each Question, the specific values used to pose and answer the question are called the Q and A Set
A Question should be based around a single activity, or a series of closely related activities.
EXAMPLES
   “Click which is More” (one question); “Click which is Less” (another question),
   “Build this Numbergram by moving counters” (one question); “Select the value of the Numbergram on the Digitline” (another question)
   “Drag a tile to the correct location on the Digitline” (one question); “Drag another tile to the correct location on the Digitline (another question).
A student provides an Answer to a question.

### Q and A Values Set:

Is the set of values specific to that instance of the question(s) that allows a specific question to be posed and answered.
May be pre-generated as part of the underlying dataset, or may be generated dynamically as needed.

### Answers:

An Answer given by a student can be evaluated by how close it is to the desired response.
An answer that is Exactly Correct achieves the standard maximum score (e.g. 100)
It is possible, in some cases, to get more than 100 for an exemplary answer.
Other answers, that are not “Exactly Correct” can be said to be a quantifiable “distance” or Closeness from being correct.
Closeness Values range from 0 to 99, though practical examples like “off by one” may receive a closeness score of (say) 79, not 99.

### Mistakes:

In answering a question, a student may make one or more Mistakes.
The number and category (or “type”) of Mistakes made are accumulated during the course of answering each question. These are then used to calculate a Mistakes Score.
Some categories of mistakes are more serious than others and receive a different score accordingly.
The Score for each Mistake can be, but is not required to be, directly associated with the closeness score.
Example: A student is asked to place a number 23 tile on a ten by ten grid representing the numbers 1 to 100.
Depending on where they place it they could make the following mistakes (possible mistake scores are shown as examples):
   off-by-one (very close. Mistake Score=25)
   off-by-two (fairly close. Mistake Score=50)
   off-by-three (not really close. Mistake Score=75)
   off-by-ten (very close. Mistake Score=25)
   digit transposition [placed tile on number 32] (digit transposition. Mistake Score=25)

### Scores

A variety of scores are generated and used by the system. They include:
Assistance Score: The value represents the total amount of assistance provided (either visually or verbally) that could contribute to the student getting either the current question correct, or a higher score. Subtracted from the maximum possible score value.
Difficulty Score How difficult a specific Question is in relation to others within the current lesson. Can be applied to Questions assessing the same Micro-objective as well as those assessing different Micro-objectives
Mistakes Score: The value represents the combination of the quantity and category of all mistakes made by the student while answering the question. Often determined by how “close” the student was to being correct.
Responsiveness Score: How quickly the student responded when compared to other students who have answered this this type of question in this lesson previously. The student's responsiveness may be compared against a specific subset all the students—for example students of similar age, learning style, or learning or physical disability—to obtain a more appropriate/accurate score. Question Score: The final score for the question calculated from all other contributing scores (e.g. mistakes, assistance, responsiveness, difficulty, etc.). Used to calculate both the Current Progress score and the score for the Micro-objective associated with this question.
Current Performance Score: A score calculated from recent Question Scores across all the micro-objectives recently assessed. Provides a general indication of how well the student is doing on the lesson as a whole at that moment. May be restricted to scores from questions asked within the current lesson phase.
Micro-Objective Score: A score calculated from the most recent Question Scores for a specific micro-objective. Provides an indication of either how well the student is responding to questions of a specific type or how well they have mastered the specific concept or skill associated by that micro-objective. When the lesson completes, each Micro-objective score (there may be more than one per lesson) represents the student's level of mastery of the specific skill or knowledge being assessed by each. May be further adjusted by any Completeness or Effectiveness scaling factors applied by the system. For example, a lesson may have a far higher Effectiveness Factor for students whose learning style is more visual than auditory.

### Micro-Objectives:

The smallest unit of knowledge or skill assessed for a specific lesson. Example: “Student can recognize the lesser of two single digit numbers”

### Completeness Factors:

Literally, how completely the lesson covers a specific Micro-objective. For example, a possible Micro-objective might be “Student can compare unequal whole numbers from 1 to 10 and can identify a larger number as more than another number. (Where the difference between the numbers ranges from 3 to 5)”. A lesson author, for whatever reason, might decide a lesson will cover and assess only those numbers from 1 to 6. Alternatively they might cover the range 1 to 10, but only have a difference of 5. In either case the lesson does not assess the complete micro-objective. While the student may do very well within the lesson, their final micro-objective score(s) need to be scaled by how completely the lesson assesses each micro-objective it addresses.

### Effectiveness Factors:

Multiple lessons may cover and assess similar or identical subject matter. Therefore they may assess the same, or many of the same, micro-objectives. They may teach the concepts and skills in entirely different ways, however. By observing how students who have done similar lessons perform in later lessons that rely upon these skills, the system can calculate an Effectiveness Factor—actually potentially a number of Effectiveness Factors, since students have different learning styles and may respond quite differently to different styles of instruction—that can be used when calculating the optimal set of lessons to present next to a student.

### APPENDIX B: AXES OF ASSESSMENT

Each axis of assessment will now be discussed together with how the various categories of learners are expected to perform for that axis of assessment. In most cases, the observed data collected by the various reporters as part of the observation process 100 for a particular axis of assessment will be apparent from the discussion for that axis of assessment.

1. Number of Interactions

In one embodiment, there are an optimal number of moves or interactions that the client learning system allows for a learner to provide an answer to a question. The number of interactions may be an indicator of the strategy that a learner is using. For example, a lower performing student may take more moves than necessary to answer a question, either because they make mistakes or because they do not use a more elegant/efficient strategy to answer the question. By way of example suppose the question was to represent the number four on a ten frame i.e. a box that had 10 holes to fill in. A student may decide to take four single counters and place them each in four cells on that ten frame. Alternatively, the student could make four using a block of three counters and a single counter, or two blocks of each having two counters. So if the student used single counters and they placed each one of those in the correct locations, they would take four moves. If they took two lots of two and placed them in the correct locations, they would have two moves. Thus, the optimal number of moves or interactions in this case is two.

2. Mistakes while Answering

In many cases, the client learning system will guide a student to a correct answer. Thus, keeping track of how many times a student got the right answer would not accurately reflect the student's mastery of the subject matter being taught by the question. Thus, in one embodiment the reporters keep track of the number of mistakes made while answering questions.

3. Types of Mistakes

In one embodiment, the reporters also track and report the types of mistakes made while answering a question. In the above, where the problem was to make the number four by moving a series of counters, one of the mistakes could be taking too many interactions.

For example, in one question, the client learning system could ask “what is two plus two”?, and may provide a digit line with the numbers one through 10 as buttons for the student to click on to indicate the answer. If the student clicks on the number three, they are one unit away from the correct answer. This is an “off by one” mistake and quite different to the situation where the student clicked on the number 9. In one embodiment, the reporters track and report “off by one” mistakes to the assessment manager 412.

In one embodiment, the assessment manager uses a variety of algorithms to evaluate the mistakes made in order to work out how close or how far away a student is to getting a correct answer. For example, in some cases, the correct answer is three and a student clicks on eight which may be indicative of a common digit substitution problem where the student is mistaking the number three for the number eight. Other common digit substitution errors include mistaking two and five, and six and nine.

In embodiment, digit substitution errors are tracked and reported to the assessment manager 412.

In cases where a student is making digit substitution errors, the lesson may be adapted to provide assistance to overcome this type of error.

4. Requires Assistance

When answering a question a student may request assistance by clicking on a “help” button, responsive to which the client learning system provides assistance to the student to help the student answer the question correctly. Naturally, the value of an ultimately correct answer as an indicator of subject matter mastery is diminished by the quality and the quantity of the assistance provided. Thus, the reporters may track the quality and the quantity of the assistance provided to a student, in one embodiment.

5. Self Corrects

Lessons presented by the client learning system usually have a “button” that a student selects to submit their answer. For example, a student may place one or more tiles on a ten frame to build a number, and then will select the submit button to indicate to the client learning system that that is their final answer. When in some cases, after placement of the tiles on the ten frame, a student will realize that they have made a mistake and will change their answer by correcting the mistake before clicking the submit button. In one embodiment, the reporter tracks when a student self corrects.

6. Uses Resets when Available

Reset allows a student to reset a question so that the student may begin answering the question anew. In the case of a reset, a student has realized that a question may be answered in a “better” way. A novice usually never uses reset because they basically do not realize they are making mistakes and not answering the question in an optimal way. An expert never has to use reset because they're always answering correctly. A practitioner, which is someone who's not quite an expert, but getting there, might use one reset now and then because they'll think “Oops, I know I made a mistake, I could've done that in a better way, I'm going to try it again.” An apprentice, who is someone who is just starting to understand what's going on but is definitely a level above novice will realize that they're making mistakes but they haven't worked out yet what's the optimal way to do it is and may use reset one or two times to try and work out what is the optimal way of doing things.

7. Closeness to Correct

Given the nature of the mistakes a particular learner is making, under this axis of assessment the assessment process 106 is able to assess how close they are to being correct.

8. Demonstrates Developmental level of Understanding

Under this axis of assessment, the assessment process 106 is seeking to assess whether a student is demonstrating developmental level of understanding of the subject matter being taught. For example, a novice and apprentice may be expected to move counters in serial-fashion one at a time, whereas a practitioner or expert may be expected to move counters in groups. Likewise, a novice and apprentice may be expected to move a pointer/mouse over each counter thereby counting each counter that constitutes the answer, whereas a practitioner or expert might be expected to move the pointer directly to the answer.

9. Responsiveness

For this axis of assessment, the reporters collect timing data that measures how long it takes a student to answer a question. This axis of assessment is primarily used when the expected behavior of novices is to usually take more time to answer questions than experts (assuming they are not guessing).

The axes of assessment 1-7 discussed thus far apply to individual questions. The axes of assessment 10-12 discussed below apply across a series of questions.

10. Answers Correctly

Under this axis of assessment, the reporters track a student's answers across a whole series of questions.

11. Mistakes

Reporters track the mistakes made by a student across a whole series of questions.

12. Handles Increases in Difficulty

For this axis of assessment, the assessment process 106 evaluates how a student responds to increases in the difficulty level of questions. For example, it is expected that a novice's responsiveness will decrease dramatically with corresponding increases in question difficulty. Thus, a chart of difficulty vs. responsiveness will have a hockey stick like appearance for a novice. As a student's developmental level approaches that of an expert, it is expected that there will be a minimum impact in responsiveness for increases in question difficulty.

### APPENDIX C: HOW THE OBSERVATION AND ASSESSMENT PROCESSES ARE IMPLEMENTED

As described the observation process and the assessment process is performed by the client learning system, and involve tools, reporters and the assessment manager. What follows is a description of how the individual scores that are used in the computation of a Question Score are determined.

### Mistakes Score

The Mistakes Score accumulates for each question and is determined automatically whenever a student interacts with the system. It is a combination of two separate observations:
1. the category/type of the mistakes made
2. the number of mistakes made during the course of (hopefully) achieving the correct answer

The count, category and the score for each mistake are recorded.

### How Mistakes Score is Calculated

For each mistake the following occurs:
1. Increment the count of mistakes made.
2. Categorize the type of the mistake (e.g. digit reversal, off-by-one, etc)
3. Determine the value associated with that category of mistake. The value is usually directly related to “how close to correct” the answer was.
4. Add the value to the Mistakes Score.
5. Adjust the Mistakes Score, if necessary, possibly based upon the number of mistakes made while answering this question.

### Mistakes Categorization

Mistakes categories could include at least the following:

| DIGIT_REVERSAL (21 vs. 12) | |
|---|---|
| OFF_BY_ONE | |
| OFF_BY_TWO | |
| OFF_BY_THREE | |
| OFF_BY_NINE | (for 2D grids) |
| OFF_BY_TEN | (for 2D grids) |
| OFF_BY_ELEVEN | (for 2D grids) |
| OFF_BY_TWENTY | (for 2D grids) |

OFF_BY_A_MULTIPLE
INCORRECT_PLACEMENT
INCORRECT_PLACEMENT_MULTIPLE
INCORRECT_COLOR_OR_TYPE
INTERACTIONS_MORE_THAN_OPTIMAL
INTERACTIONS_MORE_THAN_MAXIMUM
INCORRECT_STRATEGY
INCORRECT_SELECTION
RESPONSE_TIME_EXCEEDS_MAX
RESPONSE_TIME_FAILURE
MISTAKE

### Strategy Score (Student Demonstrates Understanding)

Only applicable in lessons where there are multiple different strategies supported for answering. When available this observation can be an important indicator of student achievement. Examples of different strategies are:
dragging groups of counters vs. individual ones, to build a value
moves mouse directly to number line and clicks answer vs. moves mouse over each counter to be counted, then moves to number line to answer.

### Responsiveness Score (Timing)

How quickly a student responds once it is clear what they have to do. Can be an indicator of either understanding or automaticity in many cases. Overall time to answer a question, or series of questions, is less indicative, however, than analysis of the timing of the various mental and physical phases a student may go through to respond:
Think Time—How long the student thinks about the question(s) before beginning to respond.
Preparation Time—How long the student takes to prepare their answer. (This may be something as simple a moving their mouse cursor to where they can answer, or as complex as using some additional tools or other resources to assist in the determination of the answer(s)).
Act Time—How long it takes for the student to complete their answer. This could, for example, range from simply clicking a button, to creating a complex shape by dragging and dropping other shapes, to typing a detailed response.

By analyzing these three timings individually, as well as their summation, the system is able to make much more accurate assessments of a student's particular skills and weaknesses. For example, two students may have similar overall response times. However the first starts to respond rapidly (a short Think Time), but takes some time to complete their answer, which involves manipulating a series of objects on-screen (a long Act Time). The other takes much longer to begin responding, but completes the on-screen manipulation much faster. Neither of these responses, if taken in isolation, are necessarily strong indicators of physical or mental aptitude. However, by recording these observations over time, the system may determine that one student consistently takes more time when completing tasks that require fine motor skills (or, perhaps, properly operating computer peripherals such as a mouse) and may adjust their Adaptation Profile and score calculations appropriately.

In general, Responsiveness Scores will be calculated as follows:
Times faster than expected receive progressively higher positive scores;
Times within expectation receive a score of 0.
Times slower than expected receive progressively increasing negative scores.

### Calculating Responsiveness Scores

Responsiveness Score is determined by comparing how long the student took to answer in relation to those, or potentially a specific subset of those, who have previously used the same strategy for either this specific question, or similar questions within this lesson. Students who have response times outside a specified range—for example a Standard Deviation Multiple from the mean—will be classified as responding outside of expectations.

As with other areas of the invention, when comparing a specific student's performance—in this case responsiveness—the student may be compared against all students who have done this lesson previously or against a specific subset of students. Examples of possible subsets include students:
of similar age
similar learning style
similar learning disability
similar physical disability

An example of how the Responsiveness Score could be calculated is as follows:

The Total Response Time—the actual time in seconds the student took to respond—is determined by summation of the Think, Preparation and Act times. The previously calculated Standard Deviation and Mean values for this lesson:question combination (and ideally this lesson:question:strategy combination) are used to calculate how this specific student's response compares with the responses of the appropriate collection of previous students. Values that exceed the fast and slow thresholds set in the lesson (possibly as standard deviation multiples) are used to calculate the

Responsiveness Score. If the value falls outside either threshold, calculate the positive (for faster than expected) or negative (for slower than expected) score to apply based upon the difference from the threshold.

The system will be seeded by obtaining timings from real students and is designed to not generate Responsiveness scores until a sufficient number of responses have been obtained. As lessons and the responses of the student populations change over time, so might the timing values and the thresholds. To optimize scoring of response times the system may automatically adjust the thresholds to ensure (for example) a certain percentage of students fall within the expected range.

### Assistance Score

Assistance is defined as something that could either help the student achieve the correct answer, or improve their score for this question. The Assistance Score is a combination of two factors:
1. The quality/type of the assistance. (Essentially how “helpful” was each piece of assistance).
2. The quantity of assistance provided during the course of (hopefully) achieving the correct answer.

Assistance Scores can be generated either directly from within the lesson, for example as part of an teacher authored adaptation, or from individual lesson components that have been configured to generate an Assistance Score when interacted with in a certain way. For example, a “flash card” tool might be configured to flip and show the front rather than the back of the card to the student when clicked upon. Each flip—and the associated duration the front of the card is shown—could be automatically recorded as assistance by the lesson, if it were so configured.

### Weightings

Each of the individual assessment axis scores can be further manipulated by a weighting that adjusts how much of an impact that score has on the calculation of the overall score for each question. In one embodiment the weightings could be supplied by a teacher as part of the lesson configuration and might range in value from 0 to 2.0. A weighting of 1.0 would cause, for example, a Mistakes Score to have a “standard” impact on the final score. A value of 2.0 would cause it to have twice the impact and a score of 0 would cause the system to ignore all mistakes when calculating the final score.

In another embodiment each weighting might be made up of the combination of both a teacher supplied value in the lesson configuration, as described above, and a system calculated value that is used to adjust that value and fine tune the score calculation. E.g.

W=W_{T}*A_{S}+A_{W}

### Where:

### W=Weighting

W_{T}=Teacher supplied weighting
A_{S}=System calculated teacher weighting adjustment
A_{W}=System calculated weighting

In one embodiment the system generated adjustment value might be computed by comparing the final scores for students who do two or more lessons that assess the same micro-objectives. It might be determined that the scores for the lessons can be made to be more equal, and to more accurately represent a student's levels of skill, if one or more of the assessment axis score weightings are adjusted automatically by the system.

It should be noted that an embodiment that calculates and applies a Weighting Adjustment may be separate to that described for calculating and applying Effectiveness Factors for a lesson. Weighting Adjustments can be used to affect the scores of specific sub-groups of students within a lesson. For example, only those who make mistakes, or need assistance, since these are separately weighted. Those students who do not fall within that group will not have their scores affected. Effectiveness Factors, however, are related to the lesson itself and apply to all scores generated within that lesson. For example, in one embodiment an Effectiveness Factor of 70 would lower the score those for students who make no mistakes as well as those who make many.

### APPENDIX D: CALCULATING LESSON-INDEPENDENT MICRO-OBJECTIVE SCORE(S)

Within a lesson a student's performance on each micro-objective is nominally scored between 0 and 100, though this range can be affected by the difficulty of individual questions. This score may not be an accurate indicator of the student's level or skill or a good predictor of future performance in lessons assessing similar micro-objectives. Therefore, once outside the scope of a lesson, each micro-objective score is potentially further scaled by a teacher-supplied Completeness Factor for that micro-objective and a one of a potential set of system generated Effectiveness Factors.

In one embodiment, the final micro-objective score that is usable in a lesson-independent way could be calculated as follows:

S=S_{LD}*CF/100*EF/100

### Where:

S=Lesson Independent Micro-objective score
S_{LD}=Lesson Dependent (raw) Micro-objective score from the lesson

### CF=Completeness Factor

EF=Effectiveness Factor

1. A method, comprising:
assigning an Effectiveness Factor to a lesson, the effectiveness factor being indicative of a teaching efficacy of the lesson;
forming an expectation of a learner's performance in answering questions of the lesson;
evaluating the learner's actual performance; and
selectively adjusting the Effectiveness Factor of the lesson based on a performance heuristic.

2. The method of claim 1, wherein the performance heuristic is based on the actual performance of other learner's in answering questions of the lesson.

3. The method of claim 1, wherein evaluating the learner's actual performance is based on the Effectiveness Factor assigned to the lesson.

4. The method of claim 1, further comprising removing lessons that have an Effectiveness Factor below a threshold.

5. The method of claim 1, further comprising identifying key lessons based on a relative performance of learners across lessons.

6. A method, comprising:
providing a plurality of lessons to teach a curriculum;
assessing a learner's mastery quotient for subject matter the lessons are designed to teach;
making a set of selected lessons available to the learner based on the learner's mastery quotient;
updating the learner's mastery quotient based on the learner's responses to questions during a lesson; and
selectively changing the set by adding and removing lessons based on the updated learner's mastery quotient; wherein the learner's mastery quotient is based on scores calculated for the learner from the learner's responses to questions posed during a lesson, and on a value associated with the lesson.

7. The method of claim 6, further comprising allowing the learner the freedom to select any lesson from the set.

8. The method of claim 6, wherein each score is calculated based on a plurality of metrics relating to the learner's interaction with the lesson when answering the question.

9. The method of claim 8, wherein the metrics are selected from the group consisting of interactions, mistakes while answering, types of mistakes, assistance provided, self corrections, use of reset, closeness to correct, and responsiveness.

10. The method of claim 6, further comprising selectively adjusting the value of a lesson based on the scores.

11. A method, comprising:
for a given learner, forming an expectation of the learner's performance in answering questions of a lesson;
adapting the lesson a first time based on the expectation;
evaluating the learner's actual performance in answering questions of the adapted lesson; and
selectively adapting the lesson a second time if a difference between the expectation and the actual performance is greater than a threshold.

12. The method of claim 11, wherein evaluating the learner's actual performance is based on a heuristic.

13. The method of claim 12, wherein the heuristic comprises a performance score based on a plurality of metrics associated with the learner.

14. The method of claim 13, wherein the metrics are selected from the group consisting of interactions, mistakes while answering, types of mistakes, assistance provided, self corrections, use of reset, closeness to correct, and responsiveness.

15. The method of claim 11, wherein adapting the lesson the second time is performed while the lesson is running.

16. The method of claim 13, further comprising adjusting the performance score based on a value associated with the lesson

17. The method of claim 16, wherein the value comprises an Effectiveness Factor for the lesson.

18. The method of claim 16, wherein the value comprises a Completeness Factor associated with the lesson based on a micro-objective the lesson is designed to teach.

19. The method of claim 11, which is performed by a client device.

20. The method of claim 19, further comprising sending at least some of the metrics to a server which computes lesson adaptation control parameters to control adaption of the lesson.

21. The method of claim 20, further comprising receiving the lesson updates from the server.

22. A system, comprising:
an authentication mechanism to authenticate a learner;
a learner profile database to store a learner profile for the learner; and
an analysis engine to calculate at least one Effectiveness Factor for a lesson based student performance data.

23. The system of claim 22, wherein the adaptation manager calculates a lesson-independent Micro-Objective score based on the Effectiveness Factors.

24. The system of claim 23, wherein the student performance data is received from a client device and comprises metrics for the learner.

25. The system of claim 23, wherein the student performance data is received from multiple client devices and comprises metrics for multiple learners.

26. A computer-readable medium having stored thereon a sequence of instructions which when executed on a client machine causes the client machine to perform a method, comprising:
for a given learner, forming an expectation of the learner's performance in answering questions of a lesson;
adapting the lesson a first time based on the prediction;
evaluating the learner's actual performance in answering questions of the adapted lesson; and
selectively adapting the lesson a second time if a difference between the expectation and the actual performance is greater than a threshold.

27. The computer-readable medium of claim 26, wherein evaluating the learner's actual performance is based on a heuristic.

28. The computer-readable medium of claim 27, wherein the heuristic comprises a performance score based on a plurality of metrics associated with the learner.

29. The computer-readable medium of claim 27, wherein the metrics are selected from the group of interactions, mistakes while answering, types of mistakes, assistance provided, self corrections, use of reset, closeness to correct, and responsiveness.

30. The computer-readable medium of claim 26, wherein adapting the lesson the second time is performed while the lesson is running.

31. The computer-readable medium of claim 28, wherein the method further comprises adjusting the performance score based on a value associated with the lesson

32. The computer-readable medium of claim 31, wherein the value provides a measure of difficulty associated with the lesson.

33. The computer-readable medium of claim 31, wherein the value provides a measure of importance associated with the lesson within the context of a curriculum.

34. The computer-readable medium of claim 26, wherein the method is performed by a client device.

35. The computer-readable medium of claim 34, the method further comprises sending at least some of the metrics to a server which computes lesson adaptation control parameters to control adaption of the lesson.

36. The computer-readable medium of claim 35, the method further comprises receiving the lesson updates from the server.
